(19) United States
(12) Patent Application Publication
(10) Pub. No.: US 2007/0051454 A1
(43) Pub. Date: Mar. 8, 2007

(54) PRODUCING METHOD OF PNEUMATIC TIRE

(76) Inventor: Kazuma NISHITANI, Osaka-shi, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/470,173

(22) Filed: Sep. 5, 2006

(30) Foreign Application Priority Data
Sep. 6, 2005 (JP) 2005-257536

(51) Int. Cl. B29D 30/08

(52) U.S. Cl. 156/130.7; 156/123

(57) ABSTRACT

A producing method of a pneumatic tire includes a step of forming a sidewall rubber by winding a wide rubber ribbon around an outer periphery of a cylindrical carcass ply along a circumferential direction in a state where a central portion of the carcass ply is swelled and deformed radially outward, the wide rubber ribbon is spirally wound so as to be superimposed toward the outer side of the tire such that the wide rubber ribbon is deviated radially outward of the tire, and a radially inner end of the outermost wide rubber ribbon is disposed on a radially inner side of a tire maximum width position.

### BACKGROUND OF THE INVENTION

1. Field of the Invention

The present invention relates to a producing method of a pneumatic tire capable of preventing a crack from being generated in a sidewall outer peripheral wall.

2. Description of the Related Art

Generally, a producing method of a pneumatic tire includes a step for sequentially sticking and laminating tire rubber members extruded into a predetermined cross section shape on an outer periphery of a forming drum, and swelling a central portion of the obtained cylindrical compact radially outward and deforming the same into a toroidal shape. According to such a method, however, there is a problem that position of each rubber member is deviated or a shape of a joint portion is deformed due to a difference between an inner peripheral length and an outer peripheral length generated when rubber member is stuck on the forming drum or due to a swelling deformation thereafter, and the uniformity of the tire is deteriorated.

Hence, a Japanese Patent Application Laid-open No. 2002-200677 proposes that in a state where a central portion of a carcass band formed into a cylindrical shape is swelled and deformed, unvulcanized rubber ribbon is wound around an outer periphery of a carcass ply, and a tire rubber member such as a sidewall rubber is formed. According to this method, it is possible to prevent the above-described problem, each rubber member can precisely be formed, and it is possible to excellently ensure the uniformity of the tire.

When a sidewall rubber is formed in accordance with this method, however, it was found that, as shown in FIG. 3 for example, many interfaces of the rubber ribbon were formed in a sidewall outer peripheral wall 30, and a crack is easily generated due to a step formed along the ribbon interface. Especially, in the case of a pneumatic tire in which the tire cross section height is less than 110 mm and the oblateness (tire cross section height/tire cross section width) is small, a large distortion is applied to a region extending from a shoulder portion 3 to a tire maximum width position during running and cracks are seriously generated in such a region.

To solve the above problem, it seems to be an excellent idea to form a sidewall rubber using a rubber ribbon which is narrower than a conventional one, so that a step formed in the sidewall outer peripheral wall is reduced. According to this method, however, since the number of windings of the rubber ribbon is largely increased and thereby the forming time is increased, the productivity is deteriorated. A Japanese Patent Application Laid-open No. 2004-50985 proposes that a sidewall outer peripheral wall in a region where cracks are seriously generated is coated with a rubber sheet. In this case, however, there are a problem that the rubber sheet is easily peeled off due to air remaining between the rubber sheet and the sidewall outer peripheral wall, and a problem that the productivity is deteriorated due to the sticking operation of the rubber sheet.

### SUMMARY OF THE INVENTION

The present invention has been accomplished in view of the above circumstances, and it is an object of the invention to provide a producing method of a pneumatic tire capable of suppressing cracks generated due to a ribbon interface of a sidewall outer peripheral wall.

The object can be achieved by the present invention having the following structure. That is, the present invention provides a producing method of a pneumatic tire comprising a step of forming a sidewall rubber by winding a wide rubber ribbon around an outer periphery of a cylindrical carcass ply along a circumferential direction in a state where a central portion of the carcass ply is swelled and deformed radially outward, wherein the wide rubber ribbon is spirally wound so as to be superimposed toward the outer side of the tire such that the wide rubber ribbon is deviated radially outward of the tire, and a radially inner end of the outermost wide rubber ribbon is disposed on a radially inner side of a tire maximum width position.

According to the producing method of the pneumatic tire of the present invention, a wide rubber ribbon constituting the sidewall rubber is spirally wound such that the wide rubber ribbon is deviated radially outward toward the outer side of the tire, and an inner end of an outermost wide rubber ribbon in the radial direction is disposed on an inner side in the radial direction of the tire than a tire maximum width position. Thereby, especially in a region extending from a shoulder portion to a tire maximum width position, the ribbon interface of the sidewall outer peripheral wall can be reduced.

As a result, even with a pneumatic tire having a small oblateness, it is possible to effectively suppress a crack generated due to the ribbon interface of the sidewall outer peripheral wall. The sidewall rubber can precisely be formed by winding the wide rubber ribbon around the outer periphery of the carcass ply which is swelled and deformed, and the uniformity of the tire can excellently be secured.

In the present invention, it is preferable that the number of windings of the wide rubber ribbon is two to five. Accordingly, it is possible to effectively reduce the ribbon interface of the sidewall outer peripheral wall, and to shorten the forming time of the sidewall rubber so as to enhance the productivity.

It is preferable that the wide rubber ribbon used in the present invention has a width of 25 to 50 mm. Accordingly, it is possible to largely reduce the ribbon interface of the sidewall outer peripheral wall and to effectively prevent a crack from being generated. That is, if the width of the wide rubber ribbon is less than 25 mm, there is a tendency that the ribbon interface formed on the sidewall outer peripheral wall is increased, and the crack suppressing effect is deteriorated in some cases. On the other hand, if the width exceeds 50 mm, the superposing margin of the wide rubber ribbon becomes excessively large, and thereby the weight and cost are unnecessarily increased in some cases.

### BRIEF DESCRIPTION OF THE DRAWINGS

FIG. 1 is a semi-sectional view of a meridian showing one example of a pneumatic tire produced according to the present invention;

FIG. 2 are schematic sectional views showing a producing method of the pneumatic tire according to the invention; and

FIG. 3 is a semi-sectional view of a meridian showing one example of a pneumatic tire produced according to a conventional method.

### DESCRIPTION OF THE PREFERRED EMBODIMENTS

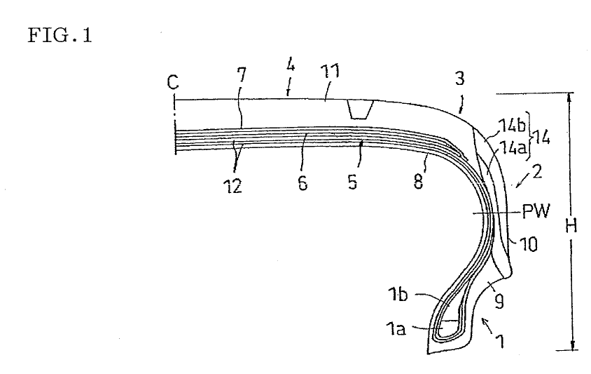

An example tire which concretely shows the structure and effect of the present invention will be explained. The pneumatic tire shown in FIG. 1 comprises a pair of bead portions 1, sidewall portions 2 respectively extending radially outward of the tire from the bead portion 1, and a tread portion 4 connected to radially outer ends of the sidewall portions 2 through shoulder portions 3. In the bead portion 1, an annular bead 1a formed by a convergence body of steel wire, and a bead filler 1b disposed radially outward of the tire of the bead 1a.

The carcass layer 5 includes at least one carcass ply comprising a ply cord extending at an angle of about 90° with respect to a tire equator C. In this embodiment, two carcass plies 12 extend between the pair of beads 1a. The cord constituting the carcass ply 12 is not limited to the polyester cord, and organic fiber such as rayon, nylon and aramid, and steel can also be used suitably.

A belt layer 6 for reinforcing the tire by hoop effect is disposed outside of a tread portion of the carcass layer 4. The belt layer 6 is formed in such a manner that two belt plies in which steel cords are inclined by about 20° with respect to the tire equator C are laminated such that the inclination angles of the steel cords are opposite from each other. A belt reinforcing layer 7 for reinforcing the hoop effect is disposed outside of the tire of the belt layer 6, and a tread rubber 11 is disposed further outer side of the tire. An inner liner rubber 8 for holding an internal pressure of the tire is disposed inside of the tire of the carcass layer 5.

A sidewall rubber 10 disposed on a sidewall portion 2 is formed by spirally winding over two turns, a wide rubber ribbon 14 made of band-like unvulcanized rubber composite along the circumferential direction of the tire according to this embodiment.

That is, although a wide rubber ribbon 14a and a wide rubber ribbon 14b laminated thereon are distinguished in FIG. 1 for the sake of convenience of explanation, they are one continuous wide rubber ribbon 14. Of the wide rubber ribbon 14, the outermost wide rubber ribbon 14b has a radially inner end located radially inner side of a tire maximum width position PW. The tire maximum width position PW means a maximum width position of the tire profile in the tire meridian cross section, and a rim protector 9 swelling outward of the tire is not taken into consideration. The producing method of the pneumatic tire will be explained.

The structure of the pneumatic tire produced according to the present invention is not limited to that described above, and the invention can also be applied to production of any tires in which a sidewall rubber is disposed on the outside of the carcass layer in the widthwise direction of the tire.

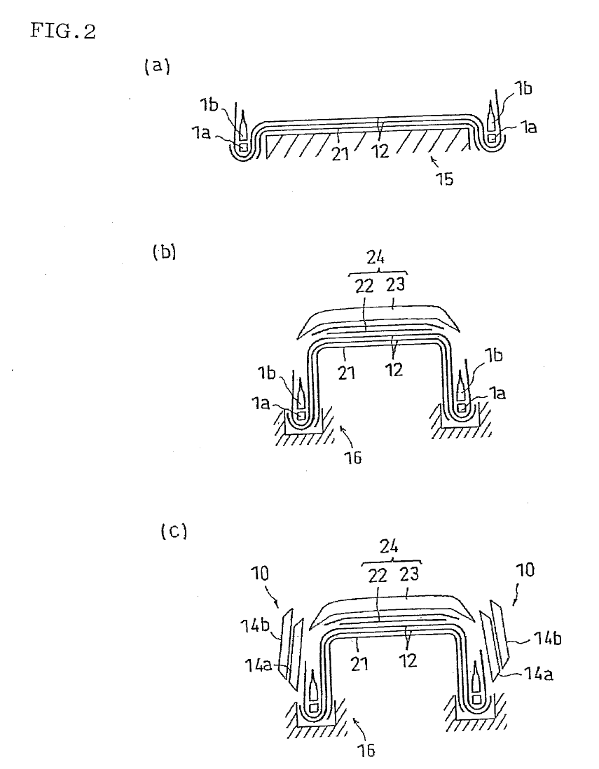

First, as shown in FIG. 2(a), an inner liner rubber member 21 which will form an inner liner rubber 8 and which has a predetermined width, and a carcass ply 12 which will form a carcass layer 5 and which has a predetermined width are sequentially wound around an outer periphery of a first forming dram 15 so as to be formed into a cylindrical shape, and a bead 1a and a bead filler 1b are fitted over each of both sides thereof in the widthwise direction.

Next, the obtained cylindrical compact is moved to a shaping drum 16. A cylindrical second case 24 comprises a belt member 22 and a tread rubber member 23. The belt member 22 constitutes a belt layer 6 and a belt reinforcing layer 7. The tread rubber member 23 forms a tread rubber 11. As shown in FIG. 2(b), the second case 24 is disposed on an outer peripheral side of a central portion of the carcass ply 12. The central portion of the carcass ply 12 is swelled and deformed radially outward, and the outer periphery of the central portion is crimped onto the second case 24. This step can smoothly be carried out by, for example, supplying air toward an inner peripheral side of the central portion of the inner liner rubber member 21 and expanding and holding the same by the internal pressure while displacing the pair of beads 1a fixed by a conventional bead lock mechanism such that the beads 1a approach each other. Although not shown in the drawings, a rubber member constituting the rim protector 9 may be disposed on an inner peripheral side of an end of the cylindrically formed carcass ply 12, and it may be wound back together with the end of the carcass ply 12.

Then, as shown in FIG. 2(c), the wide rubber ribbon 14 is spirally wound around an outer periphery side of the swelled and deformed carcass ply 12 along the circumferential direction to form the sidewall rubber 10. The wide rubber ribbon 14 is wound such that it is deviated radially outward of the tire toward the outer side of the tire, and a radially outer end of the outermost wide rubber ribbon 14b is disposed in the vicinity of the shoulder portion 3. A radially inner end of the wide rubber ribbon 14b is disposed radially inside of the tire maximum width position PW. Accordingly, it is possible to reduce the ribbon interface of the sidewall outer peripheral wall in the region extending from the shoulder portion 3 to the tire maximum width position PW so as to effectively suppress a crack.

The present invention is effective for producing a pneumatic tire having a tire cross section height H of less than 110 mm. In the case of a pneumatic tire having such a small oblateness, a large distortion is applied to a region extending from the shoulder portion 3 to the tire maximum width position PW during running. However, since the radially inner end of the outermost wide rubber ribbon 14b is disposed radially inside of the tire maximum width position PW, the sidewall outer peripheral wall in the region is formed of the wide rubber ribbon 14b, and it is possible to reduce the ribbon interface and to effectively suppress generation of cracks.

It is preferable that the width of the wide rubber ribbon 14 is 25 to 50 mm, and more preferably 28 to 45 mm. Accordingly, it is possible to largely reduce the ribbon interface of the sidewall outer peripheral wall and to effectively suppress generation of a crack. In the case of a pneumatic tire having a tire cross section height of less than 110 mm, if the width of the wide rubber ribbon 14 is 50 mm, it is sufficient to form the sidewall outer peripheral wall in the region extending from the shoulder portion 3 to the tire maximum width position PW.

It is preferable that the number of windings of the wide rubber ribbon 14 is two to five. If the number of windings is less than two, i.e., one, the step in the joint portion becomes larger, and there is a tendency that the uniformity is deteriorated. Further, it is necessary to exchange a die to be used for extrusion so as to change the cross section shape of the wide rubber ribbon everytime the tire size is changed, thereby there is a tendency that the operability is deteriorated. On the other hand, when the number of windings exceeds five, it is necessary to make the wide rubber ribbon 14 relatively thinner and thus it becomes difficult to form and wind the rubber ribbon, and there is a tendency that the forming time becomes longer.

It is preferable that the thickness of the wide rubber ribbon 14 (thickness of the thickest portion) is 1.2 to 3.0 mm. If the thickness is less than 1.2 mm, there is a tendency that the number of windings of the wide rubber ribbon 14 increases and there is a tendency that the forming time becomes longer. Since the wide rubber ribbon 14 is wound around the curved outer peripheral surface of the carcass ply 12, air is prone to enter if the number of windings is large. On the other hand, if the maximum thickness exceeds 3.0 mm, the thickness becomes excessively large when the wide rubber ribbon is wound a plurality of times, thereby it becomes difficult to form the sidewall rubber in some cases.

The cross section shape of the wide rubber ribbon 14 is not specifically limited, but it is preferable that the wide rubber ribbon 14 is provided at its side with a shape having an inclined surface such as a trapezoidal shape or a crescentic shape. Accordingly, a step along the ribbon interface formed on the sidewall outer peripheral wall can be reduced. In this case, it is preferable that the end thickness of the wide rubber ribbon 14 is 0.8 mm or less. If the end thickness exceeds 0.8 mm, there is a tendency that the effect for reducing the step is lowered.

In this embodiment, an arc wide rubber ribbon 14 having a flat triangular cross section and acute angle portions of both ends thereof are R0.2 mm is used. When a relatively wide rubber ribbon is to be extruded, since the die shape is flat, a discharge pressure of rubber at its central portion becomes greater than those at both ends, the central portion of the unvulcanized rubber composite is extruded prior to the both ends, thereby cracks are generated in both edges which receive the tensile force. However, if the ends are formed in arc shape, it is possible to suppress generation of a crack.

The winding-completion terminal end of the joint portion of the wide rubber ribbon 14 is preferably thinner than other portions. Accordingly, it is possible to reduce the step at the joint portion and to effectively enhance the uniformity of the tire. Such a wide rubber ribbon is formed by, for example, reducing the discharging amount of the winding-completion terminal end when a rubber is extruded using an extruder having a gear pump.

The winding operation of the wide rubber ribbon 14 can be carried out using a conventionally known device. For example, a winding device having a function of supplying the wide rubber ribbon 14 to the shaping drum 16 is formed such that the winding device can move in a longitudinal direction, a widthwise direction and a radial direction of a raw tire to be formed, and the rotation of the shaping drum 16 and the movement of the winding device are appropriately controlled such that a sidewall rubber 10 having a desired size and cross section shape is formed.

After the sidewall rubber 10 is formed, another rubber member is stuck to form a raw tire if necessary, a mold having a cavity in a predetermined shape is set, and vulcanization is carried out. In the present invention using the wide rubber ribbon, although it is slightly difficult to precisely form a sidewall rubber of a raw tire as compared with a case where a narrow rubber ribbon is used, a sidewall outer peripheral wall of the vulcanized tire is formed along an inner surface shape of the mold, and a pneumatic tire as shown in FIG. 1 is appropriately obtained without any specific problem.

### EXAMPLES

To concretely show a structure and an effect of the invention, endurance and productivity were evaluated as described below. A test of the endurance was carried out in accordance with a method defined in JISD4230, to search a relation between a traveled distance and a trouble. As for the productivity, time required for forming a raw tire was measured to evaluate indices. A result of a conventional example is defined as 100, and a greater numeric value means that the productivity is more excellent.

### CONVENTIONAL EXAMPLE

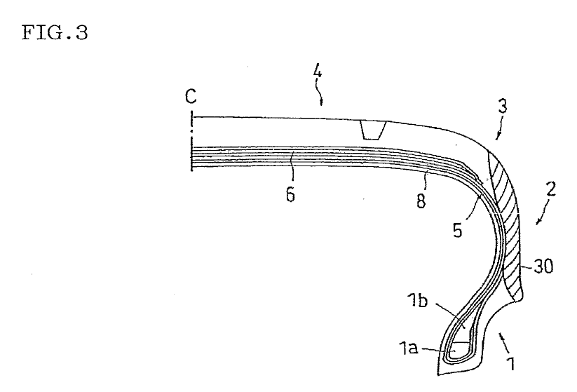

A test tire (tire size: 225/35ZR20 97W, tire cross section height: 79 mm) having a structure shown in FIG. 3 was prepared. A sidewall rubber was formed by winding a narrow rubber ribbon having a width of 20 mm and thickness of 1.5 mm eight times around an outer periphery of a carcass ply of which central portion was swelled and deformed.

### Embodiment

A test tire having a structure shown in FIG. 1 and having the same tire size as that of the conventional example was prepared. A sidewall rubber was formed by winding a wide rubber ribbon having a triangular cross section shape and a width of 36 mm and thickness of 1.7 mm (0.5 mm at the end portion) three times around an outer periphery of a carcass ply of which central portion was swelled and deformed.

TABLE 1

| | | Conventional example | Embodiment |
|---|---|---|---|
| Endurance | Traveled distance | 7000 Km | 12000 Km |
| | State of trouble | Crack in side | No trouble |

| | | |
|---|---|---|
| Productivity | 100 | 120 |

As shown in Table 1, in the conventional example, a crack was found on a sidewall outer peripheral wall when the traveled distance reached 7000 km. This crack was generated in the circumferential direction along the ribbon interface in a region extending from the shoulder portion to the tire cross section maximum width position. On the other hand, in the embodiment, a trouble such as a crack was not found even when the traveled distance reached 12000 km. From the above results, it can be found that in the embodiment, generation of a crack is suppressed and the endurance is more excellent than that of the conventional example. As compared with the conventional example in which it is necessary to wind the narrow rubber ribbon many times, it is found that the embodiment has more excellent productivity.

1. A producing method of a pneumatic tire comprising a step of forming a sidewall rubber by winding a wide rubber ribbon around an outer periphery of a cylindrical carcass ply along a circumferential direction in a state where a central portion of the carcass ply is swelled and deformed radially outward, wherein
the wide rubber ribbon is spirally wound so as to be superimposed toward the outer side of the tire such that the wide rubber ribbon is deviated radially outward of the tire, and a radially inner end of the outermost wide rubber ribbon is disposed on a radially inner side of a tire maximum width position.

2. The producing method of the pneumatic tire according to claim 1, wherein the number of windings of the wide rubber ribbon is two to five.

3. The producing method of the pneumatic tire according to claim 1, wherein a width of the wide rubber ribbon is 25 to 50 mm.

4. A producing method of a pneumatic tire including sidewall portions each having a tire maximum width position, comprising steps of:
providing a cylindrical carcass ply having a central portion swelled and deformed radially outward; and
spirally winding a wide rubber ribbon for forming each sidewall portion around each side periphery of the central portion of the cylindrical carcass ply along a circumferential direction, thereby overlapping the wide rubber ribbon toward an outer side of the tire, wherein a radially inner end of the outermost wide rubber ribbon is disposed at a position radially inward of the tire maximum width position.

5. The producing method according to claim 4, wherein the winding step comprises spirally winding the wide rubber ribbon two to five times.

6. The producing method according to claim 4, wherein the wide rubber ribbon has a width of 25 to 50 mm.

7. The producing method according to claim 4, wherein the wide rubber ribbon has a thickness of 1.2 to 3.0 mm.

8. The producing method according to claim 4, wherein the tire has a tire cross section height of less than 110 mm.

9. The producing method according to claim 4, wherein ends of the wide rubber ribbon with respect to a width direction of the wide rubber ribbon have a thickness smaller than that of a central portion of the wide rubber ribbon.

10. The producing method according to claim 9, wherein the thickness of the ends is 0.3 to 0.8 mm.

11. The producing method according to claim 4, further comprising disposing a belt member and a tread rubber member for forming a tread portion on a top periphery of the central portion of the carcass ply.
